(19) United States
(12) Patent Application Publication
(10) Pub. No.: US 2024/0208554 A1
(43) Pub. Date: Jun. 27, 2024

(54) Railway Vehicle and Method for Manufacturing Railway Vehicle

(71) Applicant: Hitachi, Ltd., Chiyoda-ku, Tokyo (JP)

(72) Inventors: Takashi MIYANAGA, Tokyo (JP); Kimiyasu YOSHIMURA, Tokyo (JP); Hideyuki NAKAMURA, Tokyo (JP); Mitsuo IWASAKI, Tokyo (JP); Takahisa YAMAMOTO, Tokyo (JP); Hiromitsu NAGAREKAWA, Tokyo (JP)

(21) Appl. No.: 17/918,252

(22) PCT Filed: Apr. 13, 2021
(86) PCT No.: PCT/JP2021/015300

§ 371 Date: Oct. 11, 2022

(51) Int. Cl. B61F 1/08

(52) U.S. Cl. CPC B61F 1/08

(57) ABSTRACT

Provided are a railway vehicle having a sufficient rigidity against an airtight load and a sufficient space in which an electrical component and the like can be mounted below an underframe, and a method for manufacturing the railway vehicle. An underframe constituting a floor surface of the railway vehicle includes: a central underframe having a hollow shape material extruded in a width direction of the railway vehicle; and a pair of end underframes each having a hollow shape material extruded in a longitudinal direction of the railway vehicle and connected to the central underframe on both sides sandwiching the central underframe.

### TECHNICAL FIELD

The present invention relates to a railway vehicle and a method for manufacturing the railway vehicle.

### BACKGROUND ART

A railroad vehicle structure generally is formed of an underframe forming a floor surface, side structures each erected at an end portion in a width direction of the underframe and forming a side surface, end structures each erected at an end portion in a longitudinal direction of the underframe, and a roof structure provided above the side structures and the end structures. In recent years, for the purpose of weight reduction and improvement of manufacturability, a method of constituting the roof structure, the side structures, the underframe, and the like, using an aluminum alloy-made hollow extruded shape material constituted of two facing face plates and a plurality of ribs connecting these face plates to each other, and assembling the roof structure, the side structures, the underframe, and the like into the railroad vehicle structure has been spreading.

Since air conditioning ducts and underfloor equipment are densely disposed in an upper space and a lower space of the underframe of the railroad vehicle structure, there is a problem of how to secure rigidity and strength against airtight pressure by the hollow shape material that avoids interference with the air conditioning ducts and the underfloor equipment. As a technique for solving this problem, PTL 1 discloses that in a railroad vehicle structure constituted of a roof structure constituting an upper surface, side structures constituting side surfaces, end structures constituting end surfaces in a longitudinal direction, and an underframe constituting a lower surface, the underframe is constituted of two face plates and a hollow shape material constituted of a rib connecting the face plates, and a thickness of a hollow shape material constituting a central portion in a width direction of the underframe is made larger than a thickness of a hollow shape material constituting end portions in the width direction of the underframe.

### CITATION LIST

### Patent Literature

PTL 1: JP 2017-121824 A

### SUMMARY OF INVENTION

### Technical Problem

Conventionally, the underframe constituting the floor surface of the railroad vehicle structure on which a relatively large airtight load acts when the railroad vehicle structure passes through a tunnel at a high speed is constituted of a central underframe disposed in a central portion of the underframe in the longitudinal direction and end underframes connected to both end portions of this central underframe in the longitudinal direction.

Since a compressive load and a tensile load between the vehicles act on the railroad vehicle structure via a pair of middle beams in which a coupler is accommodated, it is convenient that the end underframes are constituted of the hollow shape material extruded in the longitudinal (rail) direction of the railroad vehicle structure.

On the other hand, in order to mainly resist a load of the equipment provided under the floor of the railroad vehicle structure and the airtight load, the central underframe needs to have a high rigidity along a width (tie) direction of the railroad vehicle structure. Therefore, the central underframe is constituted by combining an airtight floor formed by integrally extruding a plurality of reinforcing ribs having a substantially T-shaped cross-sectional shape on a flat plate, and a plurality of cross beams that have a substantially I-shaped cross section and are formed by extruding the reinforcing ribs in the tie direction below this airtight floor.

However, in the central underframe, it is necessary to weld the plurality of cross beams to side surfaces of a pair of side beams laid along the longitudinal direction of the underframe at both end portions in the width direction of the underframe, and there is a problem to be solved in terms of manufacturability in addition to a large number of components.

An object of the present invention is to provide a railway vehicle having a sufficient rigidity against an airtight load and a sufficient space in which an electrical component and the like can be mounted below an underframe, and a method for manufacturing the railway vehicle.

### Solution to Problem

In order to achieve the above object, in one of representative railway vehicles of the present invention, an underframe constituting a floor surface of the railway vehicle includes:

a central underframe having a hollow shape material extruded in a width direction of the railway vehicle; and

a pair of end underframes each having a hollow shape material extruded in a longitudinal direction of the railway vehicle and connected to the central underframe on both sides sandwiching the central underframe.

### Advantageous Effects of Invention

According to the present invention, there can be provided a railway vehicle having a sufficient rigidity against an airtight load and a sufficient space in which an electrical component and the like can be mounted below an underframe, and a method for manufacturing the railway vehicle.

Problems, constitutions, and effects other than those described above will be clarified by the following description of embodiments.

### BRIEF DESCRIPTION OF DRAWINGS

FIG. 1 is a side view of a railroad vehicle.

FIG. 2 is a view of an underframe forming a floor surface of the railroad vehicle as viewed from below (cross-sectional view taken along line A-A of FIG. 1).

FIG. 3 is a cross-sectional view intersecting a longitudinal direction of a central underframe (cross-sectional view taken along line B-B in FIG. 2).

FIG. 4 is an enlarged cross-sectional view of a connection portion between a side beam and a central floor material that form the central underframe of a first embodiment (enlarged view of a portion D in FIG. 3).

FIG. 5 is an enlarged cross-sectional view of a connection portion between a side beam and a central floor material that form a central underframe of a second embodiment, the view corresponding to the enlarged view of the portion D in FIG. 3.

FIG. 6 is an enlarged cross-sectional view of a connection portion between a side beam and a central floor material that form a central underframe of a third embodiment, the view corresponding to the enlarged view of the portion D in FIG. 3.

FIG. 7 is a cross-sectional view of a cross beam connecting an end underframe and the central underframe, the cross-sectional view intersecting a width direction of the underframe (cross-sectional view taken along line C-C in FIG. 2).

FIG. 8 is a view schematically illustrating a process for manufacturing the central floor material of the central underframe forming the underframe.

FIG. 9 is a view schematically illustrating each unit in an exploded state when the underframe is totally assembled.

FIG. 10 is a flowchart illustrating a process for manufacturing the underframe.

### DESCRIPTION OF EMBODIMENTS

Hereinafter, embodiments of the present invention will be described with reference to the drawings. First, a railway vehicle is a general term for vehicles operated along a laid track, and indicates a railroad vehicle, a monorail vehicle, a new transportation system, and the like. Hereinafter, as a representative example of the railway vehicle, a railroad vehicle that travels at a high speed will be described.

Next, directions in the respective drawings are defined. A longitudinal (rail) direction of the railroad vehicle is an x direction, a width (tie) direction of the railroad vehicle is a y direction, and a height direction of the railroad vehicle intersecting the x direction and the y direction is a z direction. Hereinafter, it may be referred to as an x direction, a y direction, and a z direction.

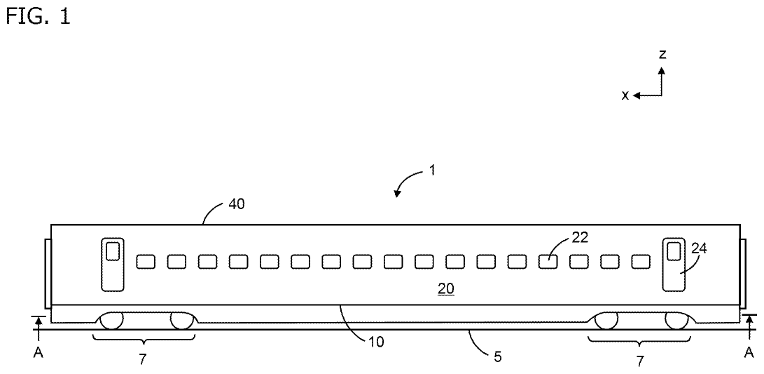

FIG. 1 is a side view of a railroad vehicle. A railroad vehicle 1 is generally a hexahedron formed of an underframe 10 forming a floor surface, side structures 20 erected at both end portions in the y direction of the underframe, end structures (not illustrated) erected at both end portions in the x direction of the underframe 10, and a roof structure 40 placed on upper end portions of the side structures 20 and the end structures. The side structures 20 each include a plurality of windows 22, entrances 24 through which passengers and the like get on and off, and the like.

The railroad vehicle 1 is supported by a truck 7 having wheels below both end portions in the x direction, and the wheels constituting the truck 7 roll on an upper surface of the track 5 along the track 5.

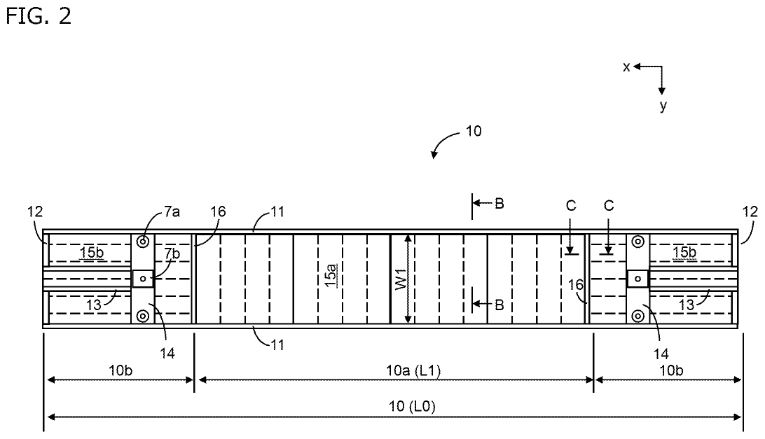

FIG. 2 is a view of the underframe forming the floor surface of the railroad vehicle as viewed from below (cross-sectional view taken along line A-A of FIG. 1). The underframe 10 is formed of a central underframe 10a provided in a central portion in the x direction of the underframe 10, and end underframes 10b provided at both end portions in the x direction of the central underframe 10a.

A pair of side beams 11 provided along the x direction at both the end portions in the y direction of the underframe 10 is provided in a manner of connecting from one end beam 12 provided at one end portion in the x direction of the end underframe 10b to another end beam 12 provided at another end portion in the x direction of the end underframe 10b across both the pair of end underframes 10b and the central underframe 10a. That is, each of the side beams 11 extends from the front end to the rear end of the underframe 10.

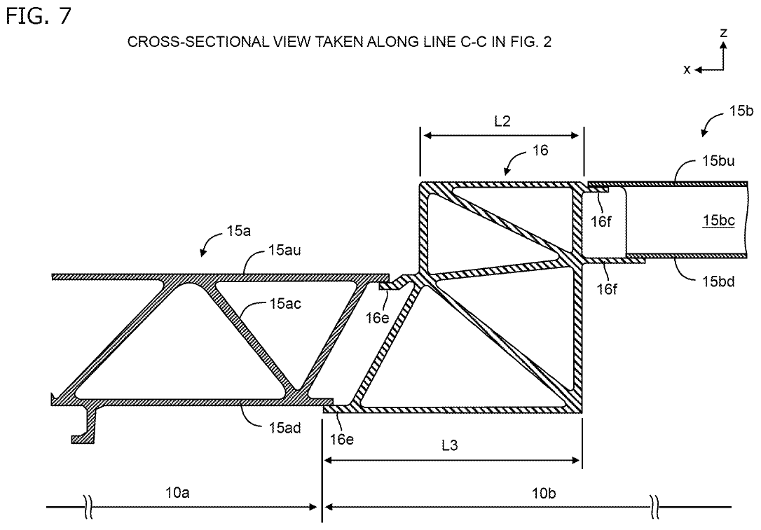

Each of the end underframes 10b is formed of an end floor material 15b formed of a hollow shape material extruded in the x direction, the end beam 12 provided at an end edge in the x direction of the end floor material 15b, the pair of side beams 11 provided at end edges in the y direction of the end floor material 15b, a cross beam 16, and a pair of middle beams 13 connecting the end beam 12 and a body bolster 14. Referring to FIG. 7, the end floor material 15b has an upper face plate 15bu, a lower face plate 15bd disposed substantially in parallel to the upper face plate 15bu, and a plurality of connection ribs 15bc connecting the upper face plate 15bu and the lower face plate 15bd.

A coupler (not illustrated) that couples the railroad vehicle is accommodated between the pair of middle beams 13. Since a large compressive load and a tensile load acting on the railroad vehicle act on the middle beams 13 via the coupler, the end underframe 10b including the middle beams 13 is required to have a high rigidity in the x direction. Therefore, the end underframe 10b includes the end floor material 15b formed of the hollow shape material extruded in the x direction.

On the other hand, the central underframe 10a is required to be able to withstand a weight of an electrical component and the like provided below the central underframe 10a, and an airtight load, and thus is desired to have a high rigidity in the y direction. Therefore, the central underframe 10a is constituted of a central floor material 15a formed of the hollow shape material extruded in the y direction, and the side beams 11 provided with both end portions in the y direction of the central floor material 15a arranged along the x direction.

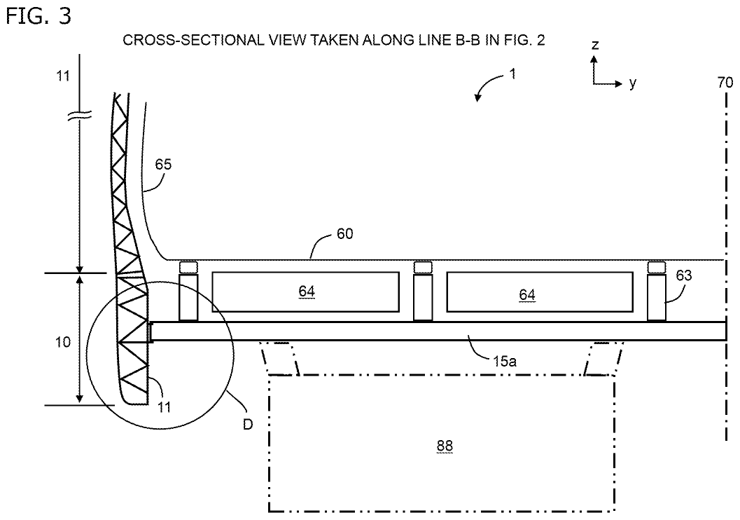

FIG. 3 is a cross-sectional view intersecting the longitudinal direction of the central underframe (cross-sectional view taken along line B-B in FIG. 2), and illustrates only one side from a center line 70 toward the side structure 20 (side beam 11). The side beam 11 along the x direction is provided at an end portion in the y direction of the underframe 10, and the side structure 20 is connected to an upper end portion of the side beam 11. The pair of side structures 20 is connected by the central floor material 15a formed of the hollow shape material extruded in the y direction.

Above the central floor material 15a, a duct 64 through which conditioned air generated by an air conditioner (not illustrated), recirculated air circulating from a vehicle interior to the air conditioner, and the like flow, and an upper floor support member 63 that supports an upper floor 60 on which seats and the like (not illustrate) are disposed are provided. A side interior material 65 is provided on a vehicle interior side of the side structure 20 from an end portion in the y direction of the upper floor 60 toward the z direction. An electrical component 88 and the like are provided below the central floor material 15a.

The central floor material 15a is constituted of the hollow shape material (double skin shape material) extruded in the y direction, by which a plurality of cross beams constituting the conventional central underframe can be omitted, and a sufficient space including the electrical component 88 and the like can be secured below the central underframe 10a.

### First Embodiment

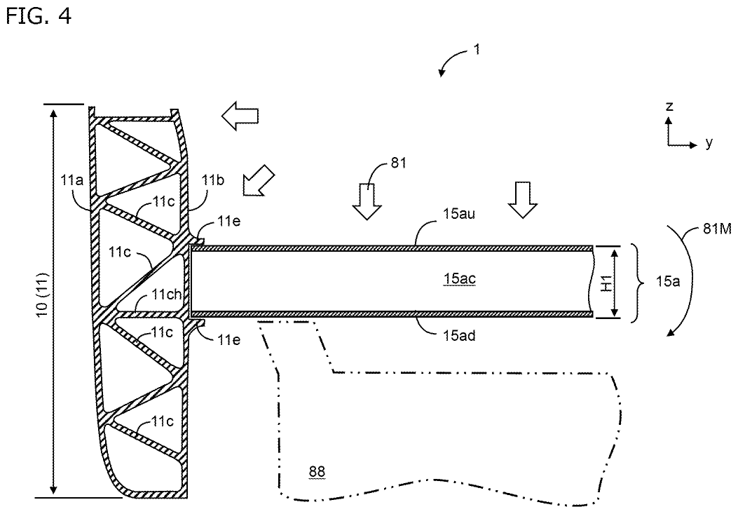

FIG. 4 is an enlarged cross-sectional view of a connection portion between a side beam forming a central underframe and a central floor material of a first embodiment (enlarged view of a portion D in FIG. 3). The side beam 11 is constituted of the hollow shape material extruded along the x direction, and includes a vehicle exterior side face plate 11a, a vehicle interior side face plate 11b placed substantially in parallel to the vehicle exterior side face plate 11a, and a plurality of connection ribs 11c connecting these two face plates.

Furthermore, a pair of locking portions 11e that locks the central floor material 15a is integrally formed on the vehicle interior side face plate 11b of the side beam 11 by extrusion. The pair of locking portions 11e is provided in the vicinity of joint portions between the vehicle interior side face plate 11b and the connection ribs 11c. The connection ribs 11c may be provided in an inclined manner or in a horizontal manner. FIG. 4 shows an example in which the connection rib 11c (connection horizontal rib 11ch) provided in a horizontal manner is connected to the vehicle exterior side face plate 11a and the vehicle interior side face plate 11b, and an end portion thereof is connected to a vicinity of the locking portion 11e on a lower side.

The central floor material 15a includes an upper face plate 15au, a lower face plate 15ad, and a plurality of connection ribs 15ac connecting these two face plates.

When each of the end portions in the y direction of the central floor material 15a abuts against the vehicle interior side face plate 11b of the side beam 11 so as to be engaged between the pair of locking portions 11e, the upper face plate 15au and the lower face plate 15ad of the central floor material 15a are joined to the vicinities of the joint portions between the vehicle interior side face plate 11b of the side beam 11 and the connection ribs 11c (the upper face plate 15au or the lower face plate 15ad, and at least a part of the joint portion overlap when viewed in the horizontal direction).

Moreover, when the side beam 11 includes the connection horizontal rib 11ch, the lower face plate 15ad of the central floor material 15a abuts on the vicinity of the joint portion with the vehicle interior side face plate 11b in a manner of being located on substantially the same plane as the connection horizontal rib 11ch of the side beam 11 (at least parts of the lower face plate 15ad and the connection horizontal rib 11ch overlap when viewed in the horizontal direction). Moreover, the upper face plate 15au of the central floor material 15a abuts on the vicinity of the joint portion between the connection rib 11c and the vehicle interior side face plate 11b (at least the upper face plate 15au and a part of the joint portion overlap when viewed in the horizontal direction).

For example, when the railroad vehicle 1 passes through a tunnel at a high speed, an airtight load 81 acts on the railroad vehicle 1 due to a pressure difference between an inside and an outside of the vehicle. According to the above constitution, when a bending moment 81M is generated in a direction in which the central floor material 15a is pushed down by the airtight load 81 acting on the railroad vehicle 1, so that the lower face plate 15ad is compressed, the upper face plate 15au and the lower face plate 15ad are joined to the vicinities of the joint portions between the vehicle interior side face plate 11b of the side beam 11 and the connection ribs 11c. Therefore, the connection ribs 11c of the side beam 11 resists the load applied to the side beam 11 by the central floor material 15a, which can suppress excessive deformation of the vehicle interior side face plate 11b of the side beam 11, so that the underframe 10 having a high strength (rigidity) can be provided.

Further, when the side beam 11 includes the connection horizontal rib 11ch, the connection horizontal rib 11ch provided on the same plane as the lower face plate 15ad resists the load of the lower face plate 15ad pressing the side beam 11, which can suppress excessive deformation of the vehicle interior side face plate 11b of the side beam 11, so that the underframe 10 having a high strength (rigidity) can be provided.

### Second Embodiment

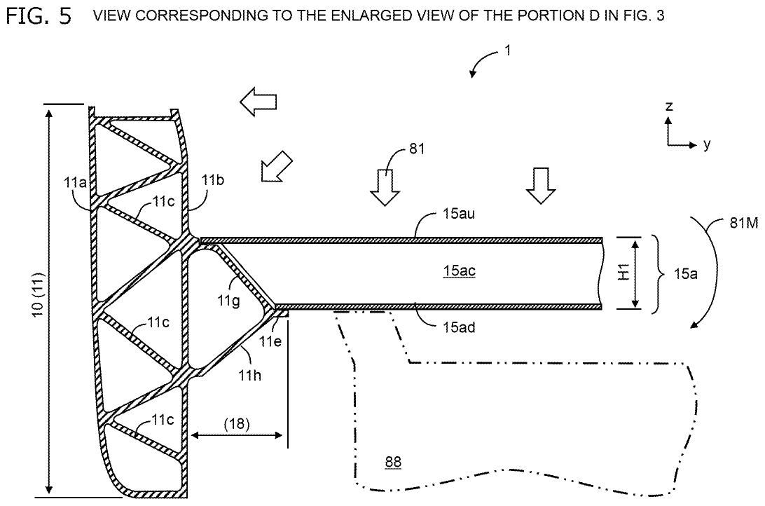

FIG. 5 is an enlarged cross-sectional view of a connection portion between a side beam and a central floor material that form a central underframe of a second embodiment, and corresponds to an enlarged view of the portion D in FIG. 3). A description of sections and functions common to the first embodiment will be omitted, and specific constitutions and functions of the second embodiment will be focused on and described.

In the second embodiment, a central floor material supporting portion 18 is provided on a vehicle interior side (side of the center line 70 in FIG. 3) of the side beam 11 integrally with the vehicle interior side face plate 11b by extrusion. The central floor material supporting portion 18 includes a first inclined plate 11g and a second inclined plate 11h, and has a substantially triangular tubular shape extending in the x direction formed of the first inclined plate 11g, the second inclined plate 11h, and the vehicle interior side face plate 11b.

One end of each of the first inclined plate 11g and the second inclined plate 11h is connected to a vicinity of a connection portion between the two connection ribs 11c and the vehicle interior side face plate 11b (the end portion and at least a part of the connection portion overlap when viewed in the horizontal direction). Another end portion of the first inclined plate 11g is connected to another end portion of the second inclined plate 11h. The locking portion 11e is integrally provided at a connection portion between the end portion of the first inclined plate 11g and the end portion of the second inclined plate 11h.

The upper face plate 15au of the central floor material 15a is joined to the connection portion between the one end portion of the first inclined plate 11g and the vehicle interior side face plate 11b, and the lower face plate 15ad of the central floor material 15a is joined to the locking portion 11e of a joint portion between the first inclined plate 11g and the second inclined plate 11h. The locking portion 11e is shifted toward the center line 70 side with respect to the connection portion between the one end portion of the first inclined plate 11g and the vehicle interior side face plate 11b. On the other hand, the end portion in the y direction of the upper face plate 15au of the central floor material 15a is shifted to a side beam 11 side with respect to the end portion in the y direction of the lower face plate 15ad. Therefore, the central floor material 15a can be easily assembled to the side beam 11.

According to this constitution, when the bending moment 81M is generated in the direction in which the central floor material 15a is pushed down by the airtight load 81 acting on the railroad vehicle 1, so that the lower face plate 15ad is compressed, the first inclined plate 11g and the second inclined plate 11h that support the lower face plate 15ad resist a load by the lower face plate 15ad pressing the side beam 11. Therefore, excessive deformation of the vehicle interior side face plate 11b of the side beam 11 can be suppressed, so that the underframe 10 having a high strength (rigidity) can be provided.

Furthermore, the rigidity in the x direction of the underframe 10 can be enhanced by the central floor material supporting portion 18 provided integrally with the side beam 11 in the x direction.

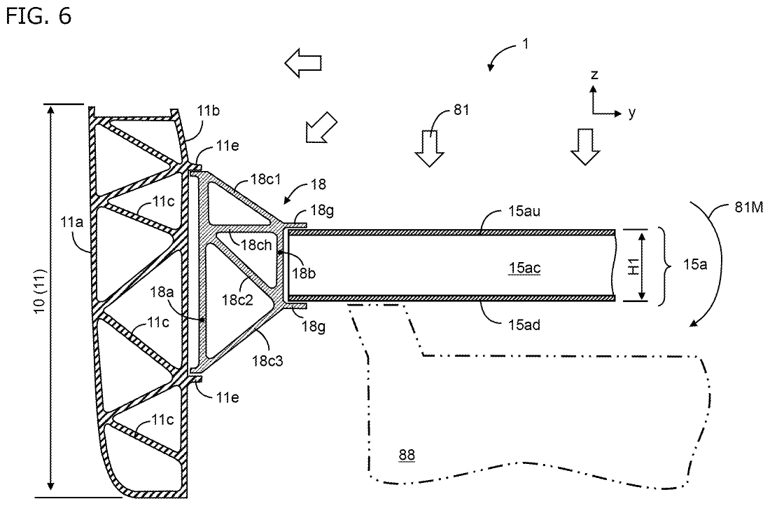

FIG. 6 is an enlarged cross-sectional view of a connection portion between a side beam and a central floor material that form a central underframe of a third embodiment, and corresponds to an enlarged view of the portion D in FIG. 3. A description of sections and functions common to the first embodiment and the second embodiment will be omitted, and specific constitutions and functions of the third embodiment will be focused on and described.

The third embodiment is an example in which the central floor material supporting portion 18 is constituted as a separate component independent of the side beam 11 and extruded in the x direction. The central floor material supporting portion 18 is constituted of a first face plate 18a along the z direction, a second face plate 18b provided substantially in parallel to the first face plate 18a, and a plurality of connection face plates 18c1 to 18c3 and a connection horizontal face plate 18ch that connect both the first and second face plates. Locking portions 18g that lock the central floor material 15a are provided at both end portions of the second face plate 18b in the z direction.

An upper end portion in the z direction of the first face plate 18a of the central floor material supporting portion 18 is connected to one of the locking portions 11e provided on the vehicle interior side face plate 11b of the side beams 11, and a lower end portion in the z direction of the first face plate 18a is connected to the other locking portion 11e provided on the vehicle interior side face plate 11b of the side beam 11.

When the end portion in the y direction of the central floor material 15a is caused to abut on the second face plate 18b of the central floor material supporting portion 18, the upper face plate 15au of the central floor material 15a is located on substantially the same plane as the connection horizontal face plate 18ch forming the central floor material supporting portion 18 (the upper face plate 15au and at least a part of the connection horizontal face plate 18ch overlap when viewed in the horizontal direction).

With this constitution, when the airtight load 81 acts on the railroad vehicle 1, the central floor material 15a is pushed down, the tensile load acts on the upper face plate 15au, and the bending moment 81M is generated in the direction in which the compressive load acts on the lower face plate 15ad, the connection horizontal face plate 18ch forming the central floor material supporting portion 18 can resists a load in which the upper face plate 15au is pulled toward the center line 70 (see FIG. 3), and the connection face plates 18c2 and 18c3 forming the central floor material supporting portion 18 can resist the load in which the lower face plate 15ad presses the side beam 11.

According to the present embodiment, it is possible to provide the underframe 10 having a high strength (rigidity) by suppressing excessive deformation of the central floor material supporting portion 18. Further, there is an advantage by constituting the central floor material supporting portion 18 as a separate component independent of the side beam 11 in place of being constituted integrally with the side beam 11 by extrusion. In the side beam 11 in a portion constituting each of the end underframes 10b having a sufficient rigidity in the x direction, the central floor material supporting portion 18 may be unnecessary. In such a case, for example, as in the above-described embodiments, when the side beam 11 and the central floor material supporting portion 18 are integrally formed by extrusion, working of removing the extra central floor material supporting portion 18 is performed for weight reduction, corresponding to the end underframe 10b, which requires man-hours. As in the present embodiment, if the central floor material supporting portion 18 having a short length in the x direction is attached to the side beam 11 as a separate component, a number of manufacturing steps of the underframe can be reduced.

In order to reduce the weight, a central floor material supporting portion 18 in which the connection face plate 18cl of the central floor material supporting portion 18 is omitted, and a dimension in a height direction of the first face plate 18a is set to a dimension from the connection horizontal face plate 18ch to a lower end portion of the connection face plate 18c3 may be adopted.

FIG. 7 is a cross-sectional view of the cross beam connecting the end underframe and the central underframe, the cross-sectional view intersecting the width direction of the underframe (cross-sectional view taken along line C-C in FIG. 2). The cross beam 16 is provided closer to a central portion in the x direction of the underframe 10 in the end underframe 10b, and is used to connect the end underframe 10b and the central underframe 10a.

The cross beam 16 is a member formed of a hollow shape material formed by extrusion in the y direction, and integrally includes a rectangular cross-sectional shape in an upper portion and a substantially trapezoidal cross-sectional shape in a lower portion. Therefore, an x-direction dimension L2 of a lower end portion of the cross beam 16 is set larger than an x-direction dimension L1 of an upper end portion of the cross beam 16. Locking portions 16f that lock an end portion in the x direction of the end floor material 15b constituting the end underframe 10b are provided in the upper portion of the cross beam 16, and locking portions 16e that lock an end portion in the x direction of the central floor material 15a constituting the central underframe 10a are provided in the lower portion of the cross beam 16. Of the pair of locking portions, the locking portion 16e on a lower side in the z direction is shifted toward a central underframe 10a side with respect to the locking portion 16e on an upper side in the z direction. On the other hand, an end portion in the x direction of the upper face plate 15au of the central floor material 15a is shifted toward a cross beam 16 side with respect to an end portion in the x direction of the lower face plate 15ad.

With this constitution, when the underframe 10 is fully assembled, after joining the pair of end underframes 10b and the pair of side beams 11, only by placing the central floor material 15a on the cross beam 16 while hanging down from above, the end portions of the upper face plate 15au and the lower face plate 15ad of the central floor material 15a can be connected to the two locking portions 16e of each of the cross beams 16.

With the above constitution, in particular, it is possible to provide a railroad vehicle including the underframe 10 having a sufficient rigidity against an airtight load and the like by using an extruded shape material in which the extrusion direction is the y direction while the central underframe 10a can be manufactured with a small number of components. Furthermore, according to the above constitution, since the plurality of cross beams constituting the conventional central underframe are not used, a height-direction dimension of the central underframe can be reduced, so that it is possible to provide a railroad vehicle having a sufficient space in which an electrical component and the like can be mounted below the underframe.

### <Method for Manufacturing Underframe>

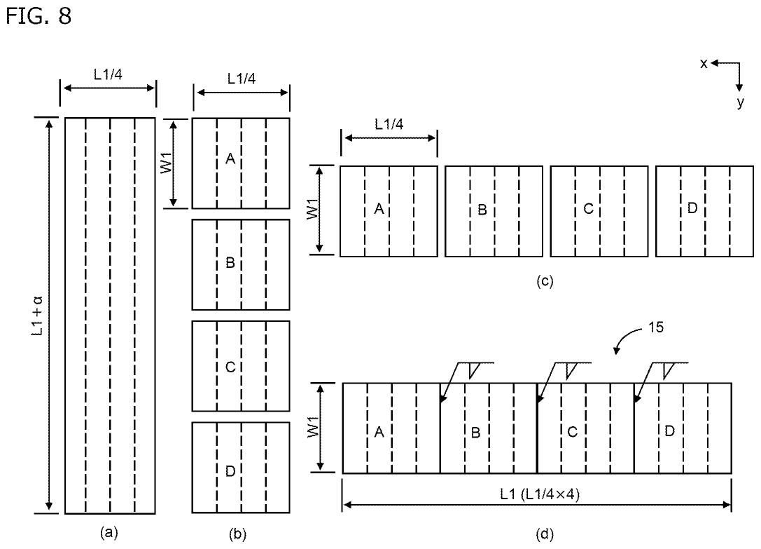

FIG. 8 is a view schematically showing a process for manufacturing the central floor material of the central underframe forming the underframe. Here, after the hollow extruded shape materials are arranged side by side on a surface plate, these shape materials are joined to manufacture a panel on which the central floor material 15a is based. At this time, an extrusion-direction dimension of the hollow extruded shape material is a dimension obtained by adding a machining allowance dimension a to an x-direction dimension L1 of the central floor material 15a when the central floor material 15a is incorporated in the underframe 10 (FIG. 8 (a)).

Next, this panel is cut into four panels A to D (exemplified) by an extrusion-direction dimension W1 in a direction intersecting the extrusion direction. This dimension W1 is a y-direction dimension of the central floor material 15a when the central floor material 15a is incorporated in the underframe 10 (FIG. 8 (b)).

Next, the cut panels A to D are arranged on the surface plate side by side with the extrusion direction aligned in a direction intersecting the extrusion direction of the hollow extruded shape material (FIG. 8 (c)), and then the panels A to D are joined by welding to manufacture the central floor material 15a having the y-direction dimension W1 and the x-direction dimension L1.

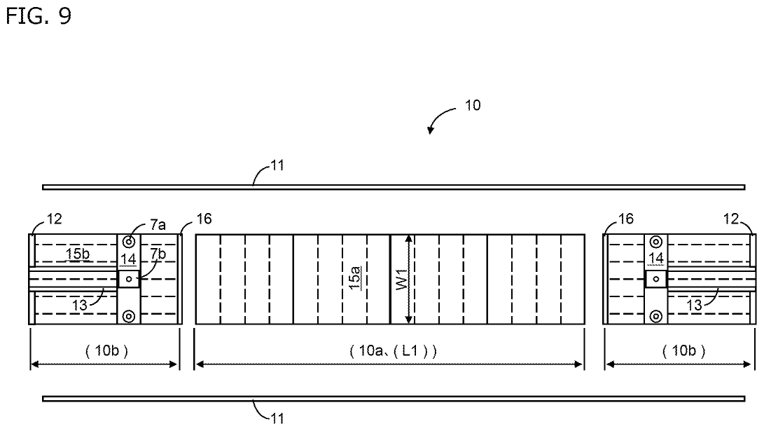

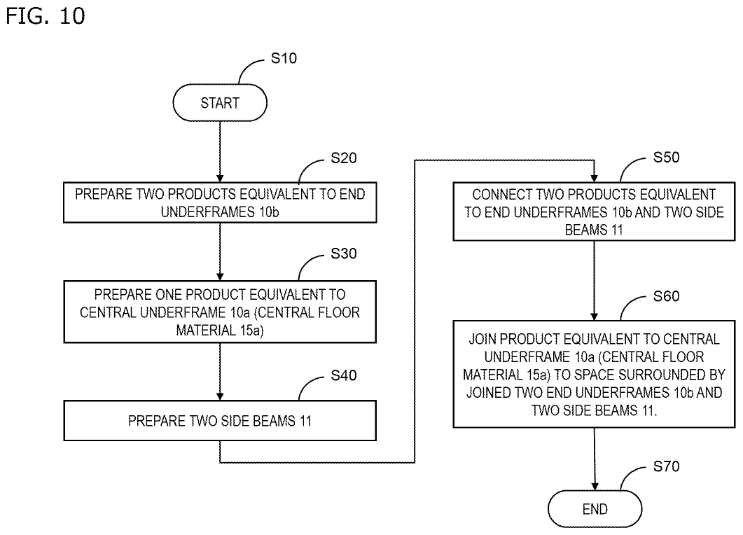

FIG. 9 is a view schematically illustrating each unit in an exploded state when the underframe is totally assembled, and FIG. 10 is a flowchart illustrating a process for manufacturing the underframe. Hereinafter, the process of assembling the underframe 10 will be described step by step.

In step S10, assembly of the underframe 10 starts.

In step S20, two structures corresponding to the end underframes 10b each formed of the end beam 12, the cross beam 16, the end floor material 15b, the body bolster 14, and the middle beam 13 are prepared.

In step S30, as illustrated in FIG. 8, one structure corresponding to the central underframe 10a formed of the central floor material 15a having the total length L1 (x-direction dimension) is prepared.

In step S40, the two side beams 11 each having a total length L0 (x-direction dimension) are prepared.

In step S50, the structures corresponding to the end underframes 10b and the side beams 11 are connected to manufacture a framework of the underframe 10 having the total length L0. As a result, the framework of the underframe 10 having a rectangular space surrounded by the structures corresponding to the end underframes 10b and the side beams 11 is produced.

In step S60, the central floor material 15a having the total length L1 (x-direction dimension) is joined to the framework of the underframe 10 manufactured in step S50 to complete the underframe 10 having the total length L0.

In step S70, the assembly of the underframe 10 ends.

Note that the structures corresponding to the end underframes 10b or the structure corresponding to the central underframe 10a may be manufactured by out-work at a place other than a work place where the underframe 10 is assembled.

Moreover, although not illustrated, the underframe 10 may be manufactured by a manufacturing method including a step of assembling the frame body from the end beams 12, the body bolsters 14, the middle beams 13, the cross beams 16, which form the end underframes 10b, and the side beams 11, and a step of assembling the end floor materials 15b and the central floor material 15a to the frame body.

The underframe 10 totally assembled by the above manufacturing method makes it possible to provide a railroad vehicle including the underframe 10 having a sufficient rigidity against an airtight load and the like using the extruded shape material having the extrusion direction in the y direction. Furthermore, according to the above constitution, since the plurality of cross beams constituting the conventional central underframe are not used, the height-direction dimension of the central underframe can be reduced, so that it is possible to provide a railroad vehicle having a sufficient space in which an electrical component and the like can be mounted below the underframe.

Note that the present invention is not limited to the above-described embodiments, but includes various modifications other than the above-described embodiments. For example, the above-described embodiments have been described in detail in order to describe the present invention in an easy-to-understand manner, and are not necessarily limited to those having all the constitutions described. Moreover, a part of the constitution of one of the embodiments can be replaced with the constitution of the other embodiment, and the constitution of one of the embodiments can also be added to the constitution of the other embodiment. Moreover, for a part of the constitution of each of the embodiments, addition, deletion, or replacement of another constitution can be made.

### REFERENCE SIGNS LIST

1 railroad vehicle
5 track
7 truck
10 underframe
10a central underframe
10b end underframe
11 side beam
11a vehicle exterior side face plate
11b vehicle interior side face plate
11c connection rib
11ch connection horizontal rib
11e locking portion
11g first inclined plate
11h second inclined plate
12 end beam
13 middle beam
14 body bolster
15a central floor material
15au upper face plate
15ac connection rib
15ad lower face plate
15b end floor material
15bu upper face plate
15bc connection rib
15bd lower face plate
16 cross beam
16e, 16f locking portion
18 central floor material supporting portion
18a first face plate
18b second face plate
18c1 to 18c3 connection face plate
18ch connection horizontal face plate
18e locking portion
20 side structure
22 window
24 entrance
40 roof structure
60 upper floor
63 upper floor support member
64 duct
65 side interior material
70 center line (vehicle body width direction)
81 airtight load
81M bending moment
88 electrical component
L0 x-direction (total-length) dimension of underframe 10 (side beam 11)
L1 x-direction (total length) dimension of central underframe 10a
x longitudinal (rail) direction
y width (tie) direction
z height direction

1. A railway vehicle, wherein
an underframe constituting a floor surface of the railway vehicle includes:
a central underframe having a hollow shape material extruded in a width direction of the railway vehicle; and
a pair of end underframes each having a hollow shape material extruded in a longitudinal direction of the railway vehicle and connected to the central underframe on both sides sandwiching the central underframe.

2. The railway vehicle according to claim 1, wherein
the central underframe includes a central floor material constituted of the hollow shape material formed of an upper face plate, a lower face plate disposed substantially in parallel to the upper face plate, and a plurality of connection plates connecting the upper face plate and the lower face plate, and
each of the end underframes includes an end floor material constituted of the hollow shape material formed of an upper face plate, a lower face plate disposed substantially in parallel to the upper face plate, and a plurality of connection plates connecting the upper face plate and the lower face plate.

3. The railway vehicle according to claim 2, wherein
the underframe includes a pair of side beams provided along a longitudinal direction of the railway vehicle at both end portions in a width direction of the railway vehicle, and
each of the side beams extends across the central underframe and the end underframes from a front end of one of the end underframes to a rear end of the other end underframe.

4. The railway vehicle according to claim 3, wherein
the side beam includes a vehicle exterior side face plate, a vehicle interior side face plate placed substantially in parallel to the vehicle exterior side face plate, and a plurality of connection ribs connecting the vehicle exterior side face plate and the vehicle interior side face plate, and
the upper face plate and the lower face plate of the central floor material are connected to vicinities of joint portions between the vehicle interior side face plate and the connection ribs.

5. The railway vehicle according to claim 3, wherein
the side beam includes a vehicle exterior side face plate, a vehicle interior side face plate placed substantially in parallel to the vehicle exterior side face plate, a plurality of connection ribs connecting the vehicle exterior side face plate and the vehicle interior side face plate, and a central floor material supporting portion formed by extrusion integrally with the vehicle interior side face plate,
the central floor material supporting portion is constituted of the vehicle interior side face plate, a first inclined plate, and a second inclined plate, and has a substantially triangular tubular shape extending in a longitudinal direction of the underframe,
one end portion of each of the first inclined plate and the second inclined plate is connected to a vicinity of a connection portion between the vehicle interior side face plate of the side beam and the corresponding connection rib of the side beam,
another end portion of the first inclined plate and another end portion of the second inclined plate are connected, and
one end portion of the upper face plate of the central floor material in a width direction of the underframe is connected to a vicinity of the one end portion of the first inclined plate, and one end portion of the lower face plate of the central floor material in the width direction of the underframe is connected to a vicinity of the other end portion of the first inclined plate.

6. The railway vehicle according to claim 3, wherein
the underframe includes a central floor material supporting portion that connects the side beam and the central floor material, and
the side beam includes a vehicle exterior side face plate, a vehicle interior side face plate placed substantially in parallel to the vehicle exterior side face plate, and a plurality of connection ribs connecting the vehicle exterior side face plate and the vehicle interior side face plate,
the central floor material supporting portion includes a first face plate placed substantially in parallel to the vehicle interior side face plate of the side beam, a second face plate placed substantially in parallel to the first face plate, and a plurality of connection face plates connecting the first face plate and the second face plate,
the upper face plate of the central floor material is connected to an upper end portion of the second face plate,
the lower face plate of the central floor material is connected to a lower end portion of the second face plate, and
the corresponding connection face plate and the upper face plate are disposed on substantially the same plane.

7. A method for manufacturing the railway vehicle according to claim 1, comprising the steps of:
preparing the end underframes;
preparing a central floor material that forms the central underframe;
preparing a side beam;
connecting the side beam to the end underframes; and
connecting the central floor material to the end underframes and the side beam.

8. The method for manufacturing the railway vehicle according to claim 7, wherein
the central floor material is formed by arranging and joining extruded shape materials side by side in a direction intersecting an extrusion direction while aligning an extrusion direction, the extruded shape materials being obtained by division along the extrusion direction.

9. The method for manufacturing the railway vehicle according to claim 3, comprising the steps of:
assembling an end beam, a body bolster, a middle beam, and a cross beam that form each of the end underframes, and the side beam to a frame body; and
assembling the end floor materials and the central floor material to the frame body.
